(19) United States
(12) Patent Application Publication
(10) Pub. No.: US 2005/0169206 A1
(43) Pub. Date: Aug. 4, 2005

(54) Relay apparatus, communication system and relay method

(76) Inventor: Masanori Nozaki, Osaka (JP)

Correspondence Address: RABIN & Berdo, PC, 1101 14TH STREET, NW, SUITE 500, WASHINGTON, DC, 20005, US

(21) Appl. No.: 11/043,242

(22) Filed: Jan. 27, 2005

(30) Foreign Application Priority Data
Jan. 30, 2004 (JP) JP2004-023764

(51) Int. Cl. H04B 7/185

(52) U.S. Cl. 370/316

(57) ABSTRACT

A relay apparatus that handles dense traffic of unit data in a communication network constituted with a plurality of communication terminals each capable of sending or receiving unit data and relaying unit data transmitted by or to be received by another communication terminal, includes a band control unit that implements control so as to assign a specific communication band to a communication terminal engaged in unit data relay with priority over communication terminals not engaged in the unit data relay. The relay apparatus adopting the structure described above improves the feasibility and the level of security.

### CROSS REFERENCE TO RELATED APPLICATIONS

The disclosure of Japanese Patent Application No. JP 2004-023764 filed Jan. 30, 2004, entitled “RELAY APPARATUS, COMMUNICATION SYSTEM AND RELAY METHOD”. The contents of that application are incorporated herein by reference in their entirety.

### BACKGROUND OF THE INVENTION

The present invention relates to a relay apparatus, a communication system and a relay method, and may be adopted in, for instance, an ad hoc network.

### DESCRIPTION OF THE RELATED ART

Today, wireless access services through which an unspecified number of users carrying wireless terminals are able to access a network such as the Internet via wireless LAN access point apparatuses, Bluetooth compliant access point apparatuses or the like installed on streets, at restaurants and stores, at train stations, in hotel lobbies and the like are attracting a great deal of interest.

Such services that may be provided as commercial services by Internet service providers (ISPs) and communication business operators or may be provided free of charge to customers by restaurants and the like are offered in diverse modes.

The service area over which wireless access services are available may be expanded horizontally by increasing the range over which radio waves can be wirelessly transmitted via a plurality of access points. The principle of this method is similar to that of the cellular expansion method adopted in cellular telephones and in PHS networks in the related art.

However, the range over which radio waves can be exchanged through wireless communication technologies such as wireless LANs adopted in wireless access services is only several tens of meters, which is much shorter than the radio wave ranges achieved in cellular telephones and PHS (Personal Handy-Phone System), and the range covered by a single access point apparatus is limited to an area over a radius equal to the radio wave range, i.e., approximately several tens of meters. For this reason, a great number of access point apparatuses must be installed in order to expand the wireless access service area, which necessitates a very large investment in equipment installation.

This problem may be adequately addressed by adopting an ad hoc network technology that enables a given wireless terminal to relay data transmitted from another wireless terminal. Through the ad hoc network technology, which is also referred to as a multi-hop network technology, a network of wireless terminals is established even in an environment in which direct communication with a target communication terminal cannot be achieved by allowing a communication terminal present in the communication path to relay data. By adopting this technology, through which a wireless terminal within the communication path relays data, a wireless terminal outside the range covered by the access point apparatus is enabled to connect with the access point apparatus.

It is to be noted that the wireless terminal that relays data transmitted by (or to be received at) another wireless terminal in the ad hoc network is bound to use up resources such as power (battery power) and transmission bandwidth to relay the data on behalf of the other wireless terminals. For this reason, the user of the wireless terminal acting as a relay station should be fairly and equitably rewarded for the use of his resources.

Accordingly, Japanese Patent Laid Open Publication No. 2002-209028 discloses a technology in which wireless terminals are each equipped with a communication accounts management unit having a function with which the recipient and/or sender wireless terminal is selected as a terminal to be billed in conformance to a specific billing policy set forth in advance, a function with which a request for a terminal identifier and a voucher (which constitutes the unit for billing calculation) is issued to the selected terminal to be billed, a function with which the terminal identifier and voucher having been received are registered in a account database. This system makes it possible to bill the user of the data sender wireless terminal or the data recipient wireless terminal for the data relay service and to remunerate the user of the wireless terminal with a fee for the data relay service via an administrative organization.

### SUMMARY OF THE INVENTION

However, the technology disclosed in Japanese Laid Open Patent Publication No. 2002-209028 requires all the wireless terminals in the ad hoc network to be equipped with the communication accounts management unit having special functions. Since the ad hoc network cannot function successfully as a whole if even a single wireless terminal in the network does not have these functions, its feasibility is fairly low.

In addition, in the technology disclosed in Japanese Laid Open Patent Publication No. 2002-209028, important information such as the voucher used as the unit in the billing calculation is registered in the account database in the communication accounts management unit. Since the wireless terminals basically belong to the individual users, it is difficult to completely prevent illegal tampering with information such as the voucher in the account database by users who can use their wireless terminals freely, and thus, a high level of security is not assured.

In order to address the problems discussed above, a first invention provides a relay apparatus handling dense traffic of unit data in a communication network constituted with a plurality of communication terminals each capable of sending or receiving unit data and relaying unit data transmitted by or to be received by another communication terminal, which comprises a band control unit that implements control so as to assign a specific communication band to a communication terminal engaged to relay the unit data with priority over communication terminals not engaged in the unit data relay.

A second aspect of the present invention provides a communication system constituted with a plurality of communication terminals each capable of sending or receiving unit data and relaying unit data transmitted by or to be received by another communication terminal, which comprises a relay apparatus having a band control unit that implements control so as to assign a specific communication band to a communication terminal engaged to relay the unit data with priority over communication terminals not engaged in unit data relay.

A third aspect of the present invention provides a relay method adopted in a relay apparatus handling dense traffic of unit data in a communication network constituted with a plurality of communication terminals each capable of transmitting or receiving unit data and relaying unit data transmitted by or to be received by another communication terminal, in which control so as to assign a specific communication band to a communication terminal engaged to relay the unit data with priority over communication terminals not engaged in the unit data relay.

The present invention achieves advantages such as excellent feasibility and a high level of security.

### BRIEF DESCRIPTION OF THE DRAWINGS

FIG. 1 is a schematic diagram showing the overall structure adopted in the wireless access system achieved in a first embodiment;

FIG. 2 is a schematic diagram of an example of an essential structure that may be adopted in the access point apparatus used in the first embodiment;

FIG. 3 is a schematic diagram of a structural example that may be adopted in the token table used in the first embodiment;

FIG. 4 presents a flowchart of an example of the operation executed in the first embodiment;

FIG. 5 is a schematic diagram of an example of an essential structure that may be adopted in the access point apparatus used in a second embodiment;

FIG. 6 presents a flowchart of an example of the operation executed in the second embodiment;

FIG. 7 is a schematic diagram of an example of an essential structure that may be adopted in the access point apparatus used in a third embodiment; and

FIG. 8 presents a flowchart of an example of the operation executed in the third embodiment.

### DETAILED DESCRIPTION OF THE PREFERRED EMBODIMENTS

### (A) First Embodiment

The following is a detailed explanation of a preferred embodiment in which the relay apparatus, the communication system and the relay method according to the present invention are adopted in a wireless access system, given in reference to attached drawings. It is to be noted that in this specification and the attached drawings, the same reference numerals are assigned to components having substantially identical functions and structural features to preclude the necessity for a repeated explanation thereof.

(A-1) Structure Adopted in the Embodiment

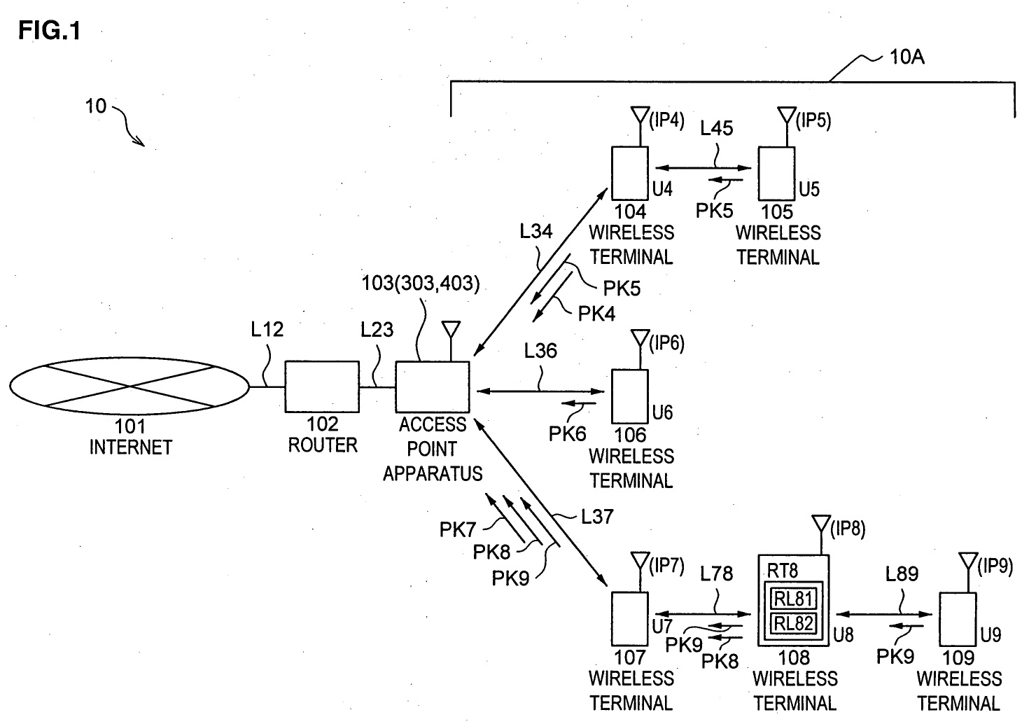

FIG. 1 shows an example of an overall structure that may be adopted in a wireless access system 10 achieved in the embodiment.

The wireless access system 10 in FIG. 1 includes the Internet 101, a router 102, an access point apparatus 103, wireless terminals 104 through 109 and transmission paths (links) L12, L23, L34, L36, L37, L45, L78 and L89.

While another network may substitute for the Internet 101, the following explanation is given on the assumption that the Internet constitutes part of the wireless access system 10.

The router 102 is a network relay apparatus that is disposed between the Internet 101 and the access point apparatus 103 and executes relay processing on the network layer an OSI reference model. The transmission path L12 connecting the router 102 and the Internet 101 and the transmission path L23 extending between the router 102 and the access point apparatus 103 are wired transmission paths (wired links). However, they may be wireless transmission paths (wireless links), instead.

While a plurality of access point apparatuses may operate under the supervision of the router 102, only one access point apparatus 103 is connected in the example presented in the figure. For this reason, the transmission speed (the transmission band) through the transmission path L12 is substantially equal to the transmission speed (the transmission band) in the transmission path L23. In most cases, the router 102 and the access point apparatus 103 are permanently installed equipment.

The access point apparatus 103 is a relay apparatus that executes relay processing on a data link layer of the OSI reference model. While the transmission path L23 is a wired transmission path, the transmission paths on the wireless terminal side, i.e., the transmission paths L34, L36 and L37 (L47, L78 and L89) are wireless transmission paths.

The wireless block constituted with the wireless terminals 104 to 109 and the access point apparatus 103 in the wireless access system 10 is referred to as a wireless network 10A. The wireless network 10A constitutes the ad hoc network described earlier.

The wireless terminals 104 to 109 may be permanently installed at the positions indicated in FIG. 1, or they may be mobile terminals.

In any case, since the transmission paths L34, L36, L37, L45, L78 and L89 are wireless transmission paths, the statuses of their presence or not can change dynamically. Each wireless transmission path (e.g., L78) is present as long as the two wireless terminals (e.g., 107 and 108) connected via the transmission path or the wireless terminal (e.g., 107) and the access point 103 connected via the transmission path are located within a wireless communication-enabled range, but it is not present if the distance between them is greater than the wireless communication-enabled range. If the wireless terminals 104 to 109 are mobile terminals, the statuses of the presence or not of the individual transmission paths change as the wireless terminals (e.g., 107) move around and the radio transmission environment changes, whereas the statuses of the presence or not of the transmission paths change as the surrounding environment in which radio waves are transmitted changes if the wireless terminals are not mobile terminals.

In addition, if the mobile terminals (e.g. 108) adopt a structure that enables them to choose not to relay data transmitted by or to be received by another wireless terminal, the statuses of the presence or not of the individual transmission paths are naturally affected by whether or not the wireless terminals are available for data relay. For instance, the transmission path L89 cannot exist if the wireless terminal 108 makes itself unavailable for data relay.

The wireless terminals 104 to 109 may be wireless communication terminals of a single type, or they may be different types of wireless communication terminals. The explanation is given on the assumption that the wireless terminals 104 to 109 are all laptop-type personal computers having loaded therein wireless LAN cards in compliance with a wireless LAN protocol (e.g., IEEE 802.11). In this case, all the wireless terminals 104 through 109 are mobile terminals.

Data may be relayed via the wireless terminal 104 to 109 on the physical layer or on the data link layer of the OSI reference model. In this example, data are relayed on the network layer. When data are relayed on the network layer, functions of the IP module (IP protocol processing software) in the OS (operating system) installed in each wireless terminal (laptop type personal computer) are likely to be needed in addition to the functions of the wireless LAN card. However, by adopting a specific installation mode, data relay may be achieved through the functions of the wireless LAN card alone.

The wireless terminal 104 is operated by a user U4. Likewise, the wireless terminal 105 is operated by a user U5, the wireless terminal 106 is operated by a user U6, the wireless terminal 107 is operated by a user U7, the wireless terminal 108 is operated by a user U8 and the wireless terminal 109 is operated by a user U9.

When a user (e.g., U8) carries his wireless terminal (e.g., 108) when he moves around, the wireless terminal, too, moves with the user.

Packets transmitted from the individual wireless terminals travel upward via the relay stations required to reach the access point apparatus 103, which further relays the packets and transmits them toward the Internet 101. A packet transmitted in the upward direction is often addressed to a server or the like on the Internet 101. While a downward packet is transmitted and relayed along a downward direction from the access point apparatus 103 side toward a wireless terminal, the following explanation focuses on the transmission of upward packets. Since the IP protocol is utilized on the network layer of the OSI reference model on the Internet 101, these packets are IP packets. In the explanation, the upward IP packets are referred to as PK 4 to PK 9.

The numerals following PK in PK 4 to PK 9 indicating the upward packets match the numerals attached at the end of the reference numeral assigned to the wireless terminal from which the corresponding packet originates. For instance, the sender of the packet PK 9 is the wireless terminal 109. After the packet PK 9 is transmitted from the wireless terminal 109, the packet PK 9 is relayed at the wireless terminal 108 and the wireless terminal 107 and is then delivered to the access point apparatus 103.

Each packet (e.g., PK 9) being transmitted is contained in a MAC frame.

Since the relay terminals (e.g., 108 and 107) themselves can transmit their own packets, FIG. 1 shows the packets PK 8 and PK 7 transmitted from these wireless terminals, as well. However, it goes without saying that a given wireless terminal that does not need to transmit a packet can engage in data relay alone.

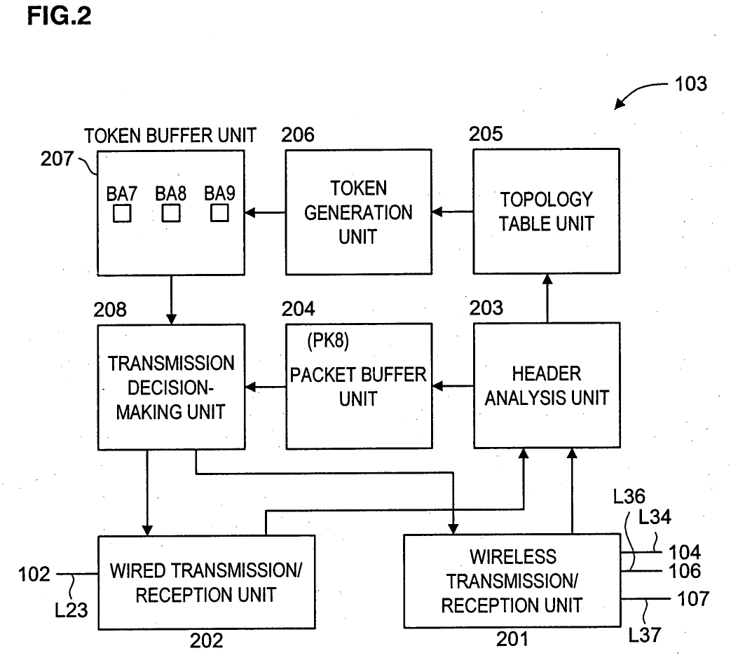

The access point apparatus 103 may adopt an internal structure such as that shown in FIG. 2.

(A-1-1) Example of Internal Structure of Access Point Apparatus

FIG. 2 shows the access point apparatus 103 comprising a wireless transmission/reception unit 201, a wired transmission/reception unit 202, a header analysis unit 203, a packet buffer unit 204, a topology table unit 205, a token generation unit 206, a token buffer unit 207 and a transmission decision-making unit 208.

The wireless transmission/reception unit 201 exchanges wireless signals (packets) with the wireless terminals 104,106,107 respectively connected with the wireless transmission/reception unit 201 via the transmission paths L34, L36 and L37, which are wireless transmission paths. As explained earlier, different wireless terminals may become connected with the wireless transmission/reception unit 201 via wireless transmission paths as the individual wireless terminals move around. The packets PK 7 to PK 9, are received at the wireless transmission/reception unit 201.

The wired transmission/reception unit 202, which is connected to the router 102 through the wired transmission path L23, transmits and receives packets. While the wired transmission/reception unit 202 receives downward packets. It also transmits packets (e.g., PK 7 to PK 9) along the upward direction.

The header analysis unit 203 analyzes the headers in the upward packets (which include PK 7 to PK 9) received at the wireless transmission/reception unit 201 and the headers in the downward packets received at the wired transmission/reception unit 202. The analysis is executed in order to obtain topology information corresponding to the wireless network 10A, and is also executed to enable band control to be implemented when relaying a packet (e.g., PK 8) containing user data after the topology information is obtained. The header analysis unit 203 may analyze MAC headers as well as packet headers (IP headers) as necessary. In addition, it may even analyze the payload portion.

Since the analysis is executed by the header analysis unit 203 in order to obtain the topology information corresponding to the wireless network 10A, the analysis target changes, depending upon how the topology information is obtained.

While various methods can be conceivably adopted to obtain the topology information, it may be typically obtained by using a control packet (to be referred to as CK) which complies with the routing protocol in the ad hoc network (the wireless network 10A).

In addition, the topology information mentioned above refers to information indicating connections among the individual wireless terminals on the wireless network 10A, i.e., information indicating which wireless terminals currently using the relay function at which wireless terminals in order to deliver upward packets to the access point apparatus 103 (in order to achieve a connection with the access point 103). The topology information for the wireless network 10A in the state shown in FIG. 1, for instance, needs to indicate that the relay function of the wireless terminal 109 is not currently available to any wireless terminals, that the wireless terminal 109 is connected to the access point apparatus 103 by using the relay function of the wireless terminals 108 and 107, that the wireless terminal 108 currently makes its relay function available to the wireless terminal 109 and is connected to the access point apparatus 103 by using the relay function of the wireless terminal 107, that the wireless terminal 107 currently makes its relay function available to the wireless terminals 108 and 109 and is directly connected to the access point apparatus 103 without having to use the relay function of any wireless terminal, and the like.

As explained above, in order to allow the individual wireless terminals to relay data on the network layer of the OSI reference model, a routing table having registered therein information (route information) used to implement route control corresponding to the current topology (the connection statuses of the wireless terminals on the wireless network 10A) of the wireless network 10A needs to be installed in each wireless terminal.

For instance, in a routing table RT 8 installed in the wireless terminal 108, route information RL 81 indicating that the wireless terminal 107 is its higher-order node and route information RL 82 indicating that the wireless terminal 109 is its lower-order node are written. The route information RL 82 is needed when transmitting a downward packet.

Since the topology of the wireless network 10A dynamically changes as the wireless terminals move around, the contents of the route information registered in the routing table, too, need to change dynamically. In order to update the route information contents, the individual wireless terminals exchange control packets CK for the route control mentioned earlier.

It is to be noted that the routing tables (e.g., RT 8) described above constitute minimum functions with which almost all wireless terminals in an ad hoc network would normally be equipped.

The topology information obtained by the header analysis unit 203 is reflected in the contents of registrations in the topology table unit 205.

The topology table unit 205 is a table based upon which the band control is executed in the access point apparatus 103. The token generation unit 206 statically (and cyclically) generates tokens in conformance to the contents of registrations in the topology table unit 205 and stores the tokens thus generated into corresponding storage areas (e.g. a storage area BA 7 corresponding to the wireless terminal 107) in the token buffer unit 207. The token generation unit 206 may also calculate the number of tokens to be generated, as detailed later, which constitutes the registration contents in the topology table unit 205, as necessary.

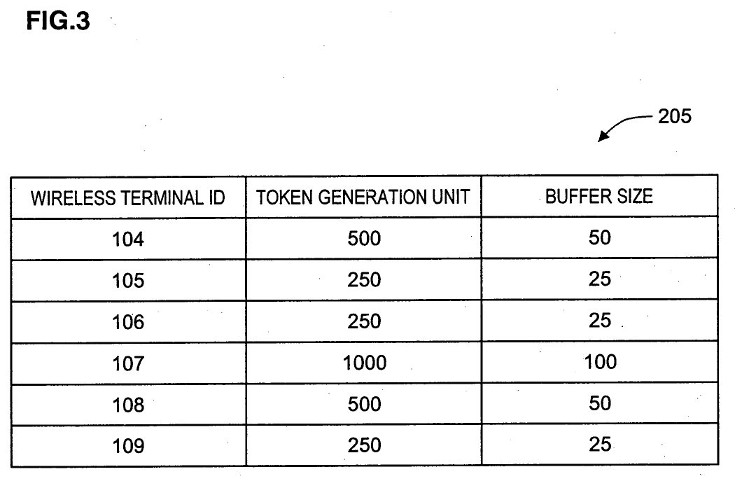

The topology table unit 205 may assume a structure and contain registered therein the registration data shown in FIG. 3, for instance.

The topology table unit 205 in FIG. 3 contains different types of data including the wireless terminal IDs, the numbers of generated tokens and the buffer sizes.

A wireless terminal ID is an identifier that allows a univocal identification of each wireless terminal in the wireless network 10A. More specifically, the wireless terminal ID of a wireless terminal may be its MAC address or its IP address. For convenience, FIG. 3 shows the reference numerals assigned to the individual wireless terminals directly used as their wireless terminal IDs. It is to be noted that while the wireless terminal IDs do not need to be constituted with the MAC addresses and/or the IP addresses of the individual wireless terminals, the structure adopted in the embodiment requires the access point apparatus 103 to recognize and manage the MAC addresses and/or the IP addresses of the various wireless terminals in one way or another for the purpose of band control. In this example, the access point apparatus 103 is assumed to manage the IP addresses of the wireless terminals.

The IP address of the wireless terminal 104 is referred to as IP 4, the IP address of the wireless terminal 105 is referred to as IP 5, the IP address of the wireless terminal 106 is referred to as IP 6, the IP address of the wireless terminal 107 is referred to as IP 7, the IP address of the wireless terminal 108 is referred to as IP 8 and the IP address of the wireless terminal 109 is referred to as IP 9.

The number of generated tokens for a given wireless terminal indicates the number of tokens generated (the token generation frequency) over a unit time length. As explained later, the number of generated tokens basically corresponds to the bandwidth allocated to the wireless terminal. For instance, the wireless terminal 107 with the number of generated tokens calculated to be 1000 is assigned with a transmission band twice as wide as that of the transmission band allocated to the wireless terminal 108 with the number of tokens generated for it calculated to be 500.

The buffer size is the size of the token buffer (storage area) secured in the token buffer unit 207 for the corresponding wireless terminal. In the token buffer unit 207, token buffers for the individual wireless terminals 104 to 109 in the wireless network 10A are secured. In this example, BA 7 indicates the token buffer for the wireless terminal 107, BA 8 indicates the token buffer for the wireless terminal 108 and BA9 indicates the token buffer for the wireless terminal 109.

Each wireless terminal (e.g., 108) is determined to operate as a packet sender or a packet receiver dynamically in response to an operation on the wireless terminal performed by the user (e.g., U8) of the wireless terminal. However, since the token generation unit 206 generates tokens statically, based upon the data in the topology table unit 205, an excessively large number of tokens may be stored in correspondence with a wireless terminal that has not sent or received a packet over an extended period of time until the band control can no longer be implemented in practical application. This problem can be solved by registering the individual buffer sizes in the topology table unit 205 and regulating the upper limit to the number of tokens that can be stored so as to achieve effective band control.

Since each buffer size indicates the maximum number of packets that can be continuously relayed at the corresponding wireless terminal, varying burst characteristics with which different levels of traffic are handled at the individual wireless terminals can be achieved by differentiating the buffer sizes allocated to the various wireless terminals.

While the buffer size allocated to each wireless terminal is in proportion to the number of tokens generated for the wireless terminal in the example presented in FIG. 3, the buffer size does not need to be in proportion to the number of tokens.

In the packet buffer unit 204, packets containing user data (e.g., PK 8) traveling upward and/or downward are temporarily stored. The control packet CK does not need to be stored in the packet buffer unit 204.

When the packet stored in the packet buffer unit 204 is to be transmitted along the upward direction or the downward direction through data relay, the transmission decision-making unit 208 makes a decision as to whether or not tokens have been stored in the token buffer corresponding to the particular packet and allows the packet to be transmitted only if a sufficient number of tokens are stored.

If a packet (e.g., PK 8) reaches the access point apparatus 103 before a sufficient number of tokens have been generated by the token generation unit 206 and stored in the corresponding token buffer (e.g., BA 8), the packet is relayed (transmitted) only after sufficient tokens are stored, and thus, the band control is implemented corresponding to the number of generated tokens.

For instance, when the unit time length is 1 sec and the average size of the packets having reached the access point apparatus 103 is 500 bytes, the communication speed (transmission band) at which packets can be transmitted from the wireless terminal 107 with the number of generated tokens at 1000 in FIG. 3 is calculated to be;
500×8×1000=4 Mbps.

In addition, each time a packet (e.g., PK 8) is transmitted, the transmission decision-making unit 208 deletes the matching number of tokens (e.g., a single token) from the corresponding token buffer (e.g., BA 8) in the token buffer unit 207.

It is to be noted that the correspondence between a packet stored in the packet buffer unit 204 and a specific token buffer can be ascertained based upon the IP address of the recipient to which the packet is addressed or the IP address of the sender of the packet. The correspondence is ascertained based upon the recipient IP address for a downward packet, whereas the correspondence is ascertained based upon the sender IP address for an upward packet.

For instance, in the case of PK 8, which is an upward packet, the sender IP address written in its IP header indicates IP 8, i.e., the IP address of the wireless terminal 108, and accordingly, the transmission decision-making unit 208 needs to determine whether or not tokens are stored in the token buffer BA 8.

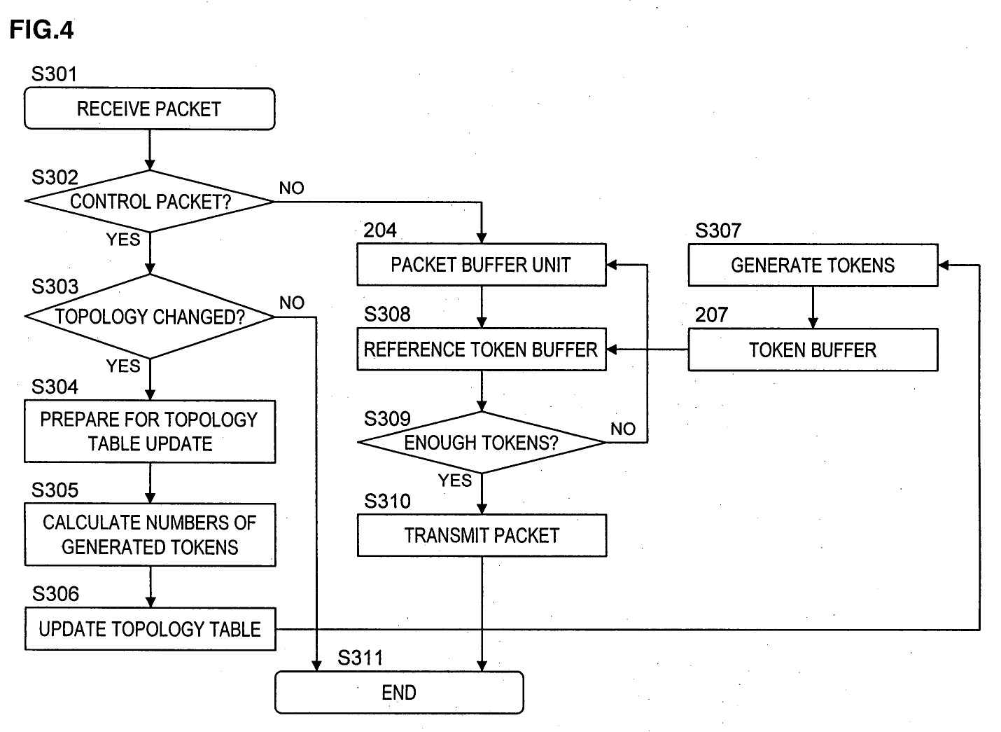

The following is an explanation of the operation executed in the embodiment adopting the structure described above, given in reference to FIG. 4. FIG. 4 presents a flowchart of the operation executed in steps S301 through S311 at the access point apparatus 103.

It is assumed that the current topology of the wireless network 10A is as shown in FIG. 1 and that the contents of the topology table are as shown in FIG. 3.

(A-2) Operations Executed in the Embodiment

Upon receiving a packet (S301), the access point apparatus 103 checks the packet to determine whether or not it is the control packet CK (S302). However, in the configuration shown in FIG. 1 and FIG. 2, the control packet CK is received only at the interface with the wireless network 10A, i.e., only at the wireless transmission/reception unit 201, and for this reason, the check in step S302 may be skipped if the packet is received at the wired transmission/reception unit 202.

If the received packet is determined to be the control packet CK, step S302 branches to the YES flow to make a decision as to whether or not the topology of the wireless network 10A has changed. If the topology has not changed (branching to the NO flow in FIG. 303), the processing ends for the time being and the operation waits for the arrival of a new packet (S311).

If the topology has changed, preparation for updating the current contents of the topology table unit 205 is made (S304). If a new wireless terminal has become part of the wireless network 10A, if an existing wireless terminal drops out of the wireless network 10A or if a change has occurred in the connections among the existing wireless terminals without any wireless terminal added into or dropping out of the network, the topology changes and the control packet CK is received.

If the topology has changed due to the addition of a new wireless terminal or the loss of an existing wireless terminal, it is necessary to add a new line or to delete an existing line in the topology table.

Since a typology change necessitates an adjustment in the values of the numbers of generated tokens, the numbers of generated tokens are calculated anew (S305) and the values of the numbers of generated tokens in the topology table are updated based upon the calculation results. It goes without saying that if the buffer sizes of the token buffers (e.g., BA 8) are in proportion to the numbers of generated tokens, the values representing the buffer sizes, too, need to be updated at this time.

The registration contents in the topology table are then updated by reflecting the updated numbers of generated tokens and the updated buffer size values (S306).

The token generation unit 206 generates tokens over cycles corresponding to the contents (in particular the numbers of generated tokens) in the updated topology table and stores the generated tokens into the corresponding token buffers (S307).

If, on the other hand, the packet received in step S301 is not the control packet CK but a packet containing user data (e.g., PK 8), the operation branches into the NO flow in step S302 and the packet is stored in the packet buffer unit 204.

Next, the transmission decision-making unit 208 references the token buffer corresponding to the packet stored in the packet buffer unit 204 (S308), and makes a decision as to whether or not tokens are stored therein (S309). If a sufficient number of tokens is stored, the transmission decision-making unit 208 enables transmission and the operation branches into the YES flow in step S309 to transmit the packet (S310).

However, if sufficient tokens are not stored, the transmission decision-making unit 208 does not enable transmission and instead checks another packet stored in the packet buffer unit 204. Subsequently, until the transmission decision-making unit 208 finds a packet, the transmission of which can be enabled, it repeatedly executes the loop constituted with steps S308 and S309.

A wireless terminal (e.g., 107) offering its relay function to a greater number of wireless terminals in FIG. 1 has a greater number of generated tokens in the topology table and, accordingly, it is assigned with a wider transmission band.

In contrast, a wireless terminal (e.g., 109) that does not offer its relay function to another wireless terminal has a smaller number of generated tokens and, accordingly, it is assigned with a narrower transmission band.

Normally, each wireless terminal is unlikely to use up the entire transmission band allocated to it by the access point apparatus 103 and thus, an advantage is achieved in that when wireless terminals using the relay function of a given wireless terminal (e.g., the wireless terminals 108 and 109 using the relay function of the wireless terminal 107) are not engaged in packet exchange, a wide transmission band can be utilized by the provider of the relay function (e.g., the wireless terminal 107).

It is to be noted that in an application of FIG. 3, it is desirable to ensure that the difference obtained by subtracting the total of the transmission bands allocated to a single or a plurality of wireless terminals using the relay function of a given wireless terminal (the wireless terminals 108 and 109 using the relay function of the wireless terminal 107) from the transmission band allocated to the wireless terminal (107) offering its relay function to these wireless terminals is greater than the transmission band allocated to any of the wireless terminals using the relay function.

For instance, when the numbers of generated tokens (corresponding to the transmission bands) allocated to the wireless terminals 109 and 108 using the relay function of the wireless terminal 107 are respectively 250 and 500, the wireless terminal 107 offering its relay function to them should be allocated with 1500 (=250+500+750) tokens.

In this case, control through which it is ensured that a wireless terminal offering its relay function to a greater number of wireless terminals is allowed to utilize a wider transmission band is enabled. For instance, even if a wireless terminal using the relay function of the relay terminal has used up all the transmission band allocated by the access point apparatus 103 over an extended period of time, the relay wireless terminal providing the relay function is allowed to use a wider transmission band than that allocated to the wireless terminal using its relay function.

(A-3) Advantages of the Embodiment

By adopting the embodiment, the widths of the transmission bands to be allocated to relay terminals and wireless terminals using the relay function of the relay terminals can be controlled with the functions of the access point apparatus (103) without having to equip the individual wireless terminals (e.g., 108) with special functions, and superior feasibility is achieved. It thus encourages the users of the individual wireless terminals to make their relay functions available for use by the other wireless terminals.

In addition, control can be implemented so as to ensure fairness by, for instance, rewarding a wireless terminal providing the use of its relay function to numerous wireless terminals with specific advantages while reducing to nearly zero the transmission band allocated to a wireless terminal that does not offer its relay function for use by any wireless terminal.

Furthermore, since no information that is related to any monetary value is stored in the individual wireless terminals in the system achieved in the embodiment, a higher level of security is achieved compared to the security of the technology disclosed in Japanese Laid Open Patent Publication No. 2002-209028.

### (B) Second Embodiment

The following explanation focuses on the features of the second embodiment that differentiate it from the first embodiment.

The embodiment differs from the first embodiment in that finer control is implemented by taking into consideration the number of packets relayed at each wireless terminal.

(B-1) Structure and Operation of the Second Embodiment

The structural difference between the second embodiment and the first embodiment is in the internal structure adopted in the access point apparatus.

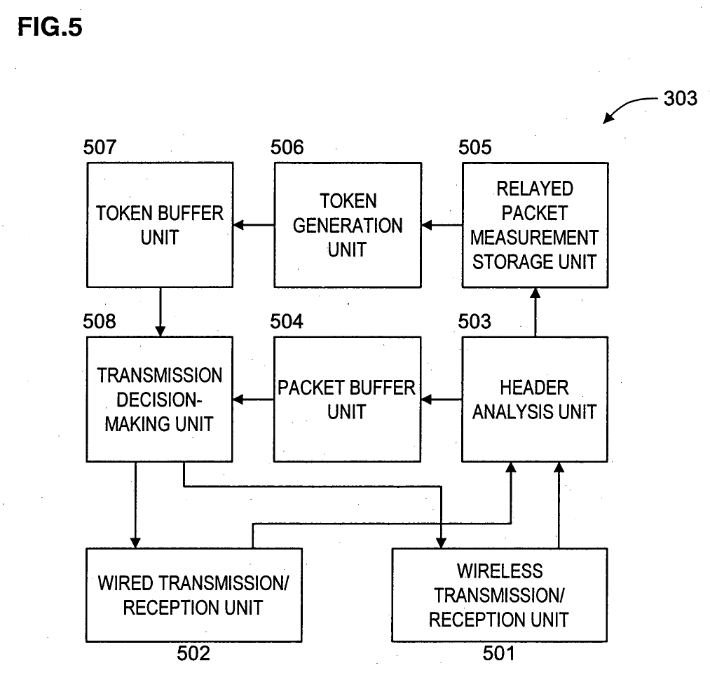

FIG. 5 shows an example of the internal structure that may be adopted in an access point apparatus 303 in the embodiment.

Since the functions of the components assigned with the same names as those of the components in FIG. 2 among components 501 to 508 in FIG. 5 match the functions achieved in the first embodiment, they are not explained in detail here.

The access point apparatus 303 in the embodiment shown in FIG. 5 only differs from the access point apparatus 103 in FIG. 2 in that it includes a relayed packet measurement storage unit 505 in place of the topology table unit 205.

The relayed packet measurement storage unit 505 detects packets received at the wireless transmission/reception unit 501 of the access point apparatus 303, each having arrived via a relay wireless terminal instead of having been directly transmitted from a sender wireless terminal and measures the number of packets having been delivered via relay terminals in real-time. The relayed packet measurement storage unit 505 also includes a table (relayed packet number table) similar to the topology table shown in FIG. 3.

The relayed packet number table differs from the topology table in FIG. 3 in that one of the various types of data contained in the table, i.e., the registration contents with regard to the numbers of generated tokens, is updated based upon the results of the measurement executed by the relayed packet measurement storage unit 505.

The relayed packet measurement storage unit 505 measures the number of relayed packets so as to allocate wider transmission bands to wireless terminals that relay greater numbers of packets. For this reason, it needs to individually measure the number of relayed packets for each relay wireless terminal.

There are numerous methods that may be adopted to make a judgment as to whether or not a packet received at the access point apparatus 303 has arrived via a relay terminal and to identify the correct relay terminal that has relayed the packet. If the topology information explained earlier is stored in the relayed packet measurement storage unit 505, the relayed packet measurement storage unit 505 is able to make a decision as to whether or not a given packet has been delivered via a relay terminal and to identify the correct relay terminal that has relayed the packet with ease based upon the topology information and the sender IP address of the received packet.

For instance, when the sender IP address of the received packet indicates IP 9, the relayed packet measurement storage unit 505 is able to ascertain based upon the IP address and the topology information, that the packet (PK 9 in this example) has been delivered to the access point apparatus 303 via the relay wireless terminals 108 and 107.

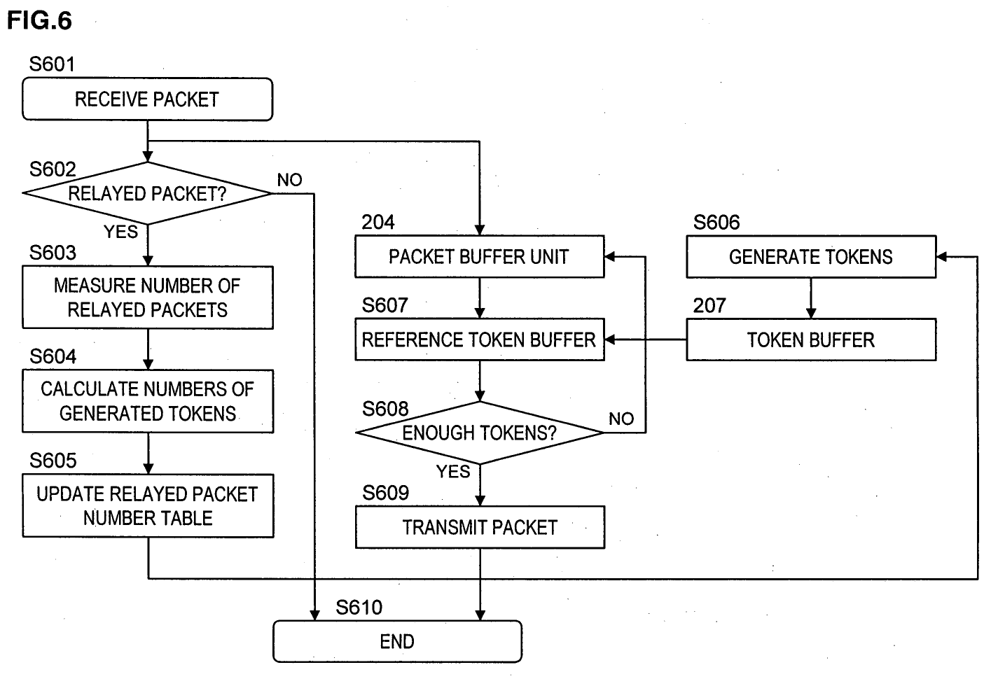

FIG. 6 presents an example of the operation executed at the access point apparatus 303.

FIG. 6 presents a flowchart of the operation executed in steps S601 through S6 10. The processing executed in steps other than steps S602 through S605 among steps S601 to S610, which is identical to the processing executed in the corresponding steps in the first embodiment, is not explained in detail here.

Instead of making a decision as to whether or not the received packet is a control packet CK, a decision is made in step S602 as to whether or not the received packet is a relayed packet (a packet delivered via a relay wireless terminal). However, the control packet CK still needs to be identified and used in the processing in order to obtain the topology information in the embodiment.

If the received packet is determined to be a relayed packet, the number of relayed packets corresponding to the wireless terminal which has relayed the particular relayed packet is incremented (+1), thereby executing the measurement of the number of relayed packets (S603).

Next, the results of the measurement are converted to the number of generated tokens (S604), and the value representing the number of generated tokens is updated (increased) in the line assigned to the corresponding wireless terminal ID in the relayed packet number table based upon the conversion results (S605).

However, since there is a limit to the size of a transmission band (e.g., the transmission band in the transmission path L23), the value representing the number of generated tokens in another line may be decreased in step S605 instead of increasing the value representing the number of generated tokens in the line assigned to the corresponding wireless terminal ID.

Subsequently, based upon the number of generated tokens thus adjusted, the token generation unit 506 and the like engage in operation to execute processing similar to that executed in the first embodiment.

(B-2) Advantages of the Second Embodiment

By adopting the embodiment, advantages similar to those of the first embodiment are achieved.

In addition, the embodiment in which control is implemented so as to allocate wider transmission bands to wireless terminals that relay greater numbers of packets enables finer control compared to the first embodiment.

### (C) Third Embodiment

The following explanation focuses on the features of the third embodiment that differentiate it from the first and second embodiments.

While the transmission bands allocated to the individual wireless terminals are controlled through the buffering function of the access point apparatus in the first and second embodiments, the transmission bands are controlled in the embodiment by using a flow control function with which most communication terminals used in TCP/IP networks and the like come equipped.

The embodiment may be considered to be more similar to the second embodiment than the first embodiment in that control is implemented based upon the results of measurement of the numbers of relayed packets.

(C-1) Structure and Operation of the Third Embodiment

The structural difference between the third embodiment and the second embodiment is in the internal structure adopted in the access point apparatus.

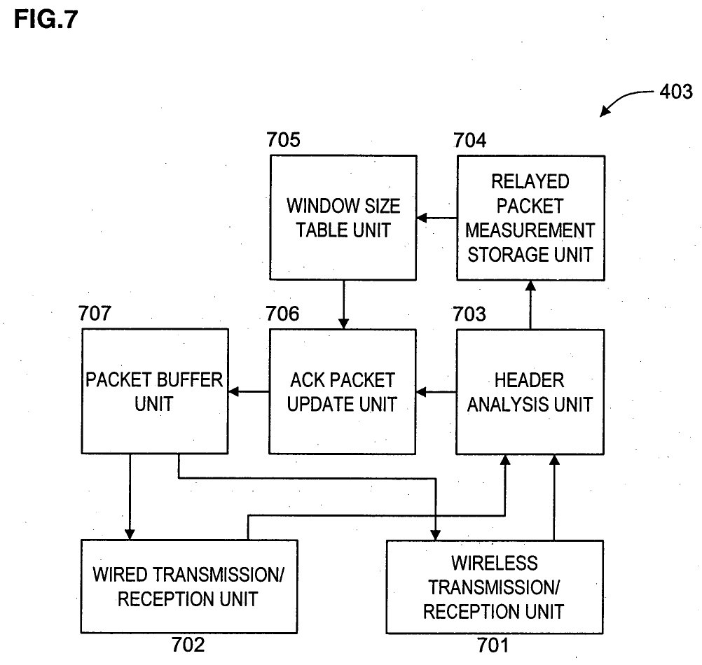

FIG. 7 shows an example an internal structure that may be adopted in an access point apparatus 403 in the embodiment.

The access point apparatus 403 in FIG. 7 comprises a wireless transmission/reception unit 701, a wired transmission/reception unit 702, a header analysis unit 703, a relayed packet measurement storage unit 704, a window size table unit 705, an ACK packet update unit 706 and a packet buffer unit 707.

The functions of the components assigned with the same names as those of the components in FIG. 5 are identical to the functions achieved in the second embodiment and for this reason they are not explained in detail.

This leave the window size table unit 705 and the ACK packet update unit 706 in FIG. 7 differentiating the embodiment from the second embodiment.

The ACK packet update unit 706 rewrites the contents of an ACK packet when the ACK packet is relayed.

An ACK packet is transmitted as an acknowledgment to the original sender (e.g., the wireless terminal 108) of a packet (e.g., PK 8) from the recipient (e.g., a server on the Internet 101) in compliance with a connection-type protocol such as the TCP protocol.

Such an ACK packet contains control information referred to as a window size. The window size indicates the volume of data that can be continuously transmitted without a delivery confirmation and thus regulates the communication speed.

The ACK packet update unit 706 rewrites the window size in the ACK packet. The ACK packet update unit 706 rewrites the window size by referencing the registration contents in the window size table unit 705.

The window size table stored in the window size table unit 705 contains registered therein window sizes each corresponding to one of the wireless terminals 104 through 109 in the wireless network 10A.

For instance, when an ACK packet addressed to the wireless terminal 108 arrives, the window size of the wireless terminal 108 is searched in the window size table and if the window size value contained in the ACK packet indicates a communication speed (which corresponds to the transmission band) higher than the window size ascertained through the search, the window size in the ACK packet is replaced with the window size ascertained through the search.

After rewriting the window size, the access point apparatus 403 relays (transmits) the ACK packet, and thus, the ACK packet is received at the wireless terminal 108 via the wireless terminal 107 in a manner similar to the manner with which a standard ACK packet is received at the wireless terminal 108. The processing executed at the wireless terminal 108 upon receiving the ACK packet is similar to that executed upon receiving a standard ACK packet.

As a result, the communication speed of each wireless terminal in the wireless network 10A is regulated corresponding to the window size registered in the window size table.

The function of the window size table corresponds to that of the relayed packet number table explained earlier. Thus, the relayed packet measurement storage unit 704 updates the window size corresponding to the individual wireless terminals that are registered in the window size table based upon the numbers of relayed packets obtained as the measurement results.

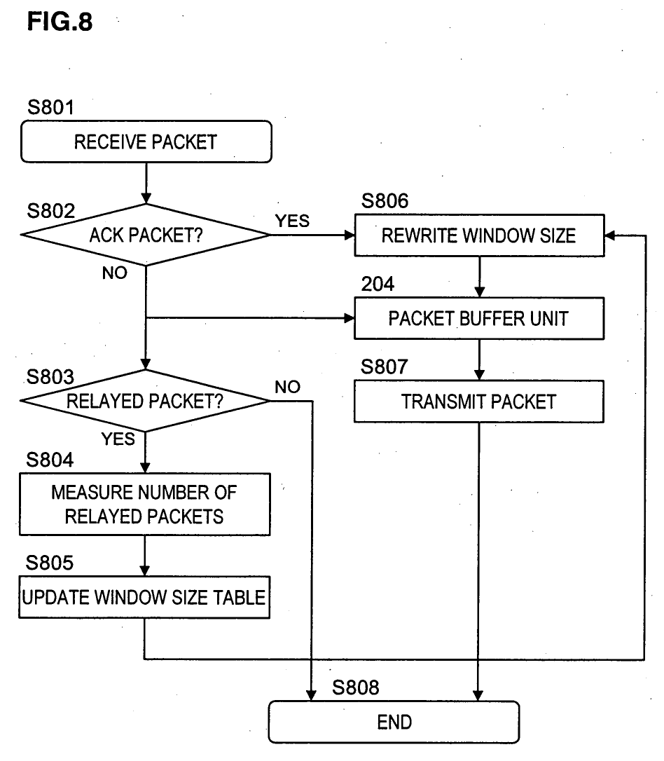

The flowchart presented in FIG. 8 summarizes the operation executed at the access point apparatus 403 as described above.

The flowchart in FIG. 8 includes steps S801 through S808.

The processing executed in steps S801, S802, 804 and S807 in FIG. 8 respectively correspond to the processing executed in steps S601, S602, S603 and S609 explained earlier, and for this reason, its detailed explanation is omitted here.

In step S802, which follows step S801 in FIG. 8, a decision is made as to whether or not the packet received at the access point apparatus 403 is an ACK packet. If it is decided that the received packet is not an ACK packet, the operation proceeds to step S803 to make a decision as to whether or not the received packet is a relayed packet. If, on the other hand, the received packet is determined to be an ACK packet, the window size in the ACK packet is rewritten (S806).

It goes without saying that if the window size contained in the ACK packet indicates a transmission band smaller than the window size ascertained through a search of the window size table, the window size in the ACK packet does not need to be rewritten.

(C-2) Advantages of the Third Embodiment

Advantages similar to those of the second embodiment are achieved by adopting the third embodiment.

In addition, the embodiment enables band control through a rewrite of the window size in the ACK packet instead of through buffering at the access point apparatus (403).

Since the ratio of packets (e.g., PK 8, etc.) containing user data in the traffic of packets handled at the access point apparatus can be assumed to be far greater than the ratio of ACK packets under normal circumstances, the access point apparatus achieved in the embodiment is highly likely to reduce the processing load compared to the access point apparatus achieved in the second embodiment which engages the transmission decision-making unit (508) to make a decision as to whether or not a transmission is to be enabled every time a packet containing user data needs to be transmitted.

### (D) Other Embodiments

It is to be noted that while the number of relayed packets is measured for each wireless terminal by the relayed packet measurement storage unit (505, 704) in the second and third embodiments, it goes without saying that the volume of relayed data (e.g., the total number of bits of the related data) or the like may be measured instead of the number of relayed packets corresponding to each wireless terminal to be used in the processing. Since packets have variable lengths, individual packets normally have different sizes (different numbers of bits).

In addition, the components used in the first through third embodiments may be combined to achieve a configuration different from those described earlier. For instance, instead of the relayed packet measurement storage unit 704 in FIG. 7, a component equivalent to the topology table unit 205 in FIG. 2 may be included in the third embodiment. In such a case, the window size contained in an ACK packet addressed to a wireless terminal is regulated corresponding to the number of wireless terminals to which the relay function of the wireless terminal is offered.

Furthermore, while the present invention is adopted in access point apparatuses that relay data on the data link layer of the OSI reference model in the first through third embodiments, it may instead be adopted in a relay apparatus (relay function) that executes relay processing on a layer other than the data link layer. For instance, the present invention may be adopted in a router or an L3 switch that executes relay processing on the network layer.

The present invention may also be adopted in compliance with a communication protocol other than that adopted in the first through third embodiments. For instance, the IPX protocol instead of the IP protocol may be adopted as the communication protocol for data communication on the network layer of the OSI reference model, and the IEEE 802.3 (CSMA/CD) or the like may be adopted instead of the IEEE 802.11 protocol as the data link layer protocol.

Namely, in any of the first through third embodiments, the present invention may be adopted in a fully wired network to a wireless network 10A and is constituted in its entirely with wired transmission paths (wired links) connecting the individual nodes. In addition, the present invention may be adopted in a network in which wired transmission paths (wired links) and wireless transmission paths (wireless links) coexist. By adopting the present invention in a fully wired network, for instance, each terminal connected via cable is able to access the Internet 101 even when the terminal (corresponds to the wireless terminal 108 or the like) cannot be directly connected with a relay apparatus (corresponds to the access point apparatus 103 or the like) via a cable.

Most of the functions realized in the hardware in the explanation given above may instead be realized in software, and likewise, most of the functions realized in software in the explanation given above may instead be realized in hardware.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

1. A relay apparatus handling dense traffic of unit data in a communication network constituted with a plurality of communication terminals each capable of sending or receiving unit data and relaying unit data transmitted by or to be received by another communication terminal, comprising:
a band control unit that implements control so as to assign a specific communication band to a communication terminal engaged in unit data relay with priority over communication terminals not engaged in the unit data relay.

2. A relay apparatus according to claim 1, wherein:
the band control unit comprising;
a positional relationship detection unit that detects positional relationships among the communication terminals on the communication network; and
a relay terminal number matching unit that detects a number of relay terminals indicating a number of sender or recipient communication terminal on behalf of which unit data are relayed by each of the communication terminals based upon the detected positional relationships and allocates wider communication bands to a communication terminals corresponding to which a greater number of relay terminals is detected.

3. A relay apparatus according to claim 1, wherein:
the band control unit comprising;
a relay frequency detection unit that detects unit data relay frequency indicating a number of sets of unit data or a volume of data relayed per unit time by each of the communication terminals; and
a relay frequency matching unit that allocates a wider communication band to a communication terminal corresponding to which a greater value representing the unit data relay frequency is detected.

4. A relay apparatus according to claim 1, wherein:
the band control unit detects flow control unit data exchanged between a sender and a recipient, which contain control information used in flow control, relays the flow control unit data after rewriting the control information and thus implements control so as to allocate the specific communication band to the communication terminal engaged in the unit data relay with priority over communication terminals not engaged in the unit data relay.

5. A communication system constituted with a plurality of communication terminals each capable of sending or receiving unit data and relaying unit data transmitted by or to be received by another communication terminal, comprising:
a relay apparatus having a band control unit that implements control so as to assign a specific communication band to a communication terminal engaged in unit data relay with priority over communication terminals not engaged in the unit data relay.

6. A communication system according to claim 5, wherein:
the band control unit in the relay apparatus comprising;
a positional relationship detection unit that detects positional relationships among the communication terminals on the communication network; and
a relay terminal number matching unit that detects a number of relay terminals indicating a number of sender or recipient communication terminals on behalf of which unit data are relayed by each of the communication terminals based upon the detected positional relationships and allocates a wider communication band to a communication terminal corresponding to which a greater number of relay terminals is detected.

7. A communication system according to claim 5, wherein:
the band control unit in the relay apparatus comprising:
a relay frequency detection unit that detects unit data relay frequency indicating a number of sets of unit data or a volume of data relayed per unit time by each of the communication terminals; and
a relay frequency matching unit that allocates a wider communication band to a communication terminal corresponding to which a greater value representing the unit data relay frequency is detected.

8. A communication system according to claim 5, wherein:
the band control unit in the relay apparatus detects flow control unit data exchanged between a sender and a recipient, which contain control information used in flow control, relays the flow control unit data after rewriting the control information and thus implements control so as to allocate the specific communication band to the communication terminal engaged in the unit data relay with priority over communication terminals not engaged in the unit data relay.

9. A relay method executed in a relay apparatus handling dense traffic of unit data in a communication network constituted with a plurality of communication terminals each capable of transmitting or receiving unit data and relaying unit data transmitted by or to be received by another communication terminal, wherein:
controlling so as to assign a specific communication band to a communication terminal engaged in unit data relay with priority over communication terminals not engaged in the unit data relay.

10. A relay method according to claim 9, wherein:
the controlling is achieved by:
detecting positional relationships among individual communication terminals on the communication network;
detecting a number of relay terminals indicating a number of sender or recipient communication terminals on behalf of which unit data are relayed by each of the communication terminals based upon the detected positional relationships; and
allocating a wider communication band to a communication terminal corresponding to which a greater number of relay terminals is detected.

11. A relay method according to claim 9, wherein:
the controlling is achieved by:
detecting unit data relay frequency indicating a number of sets of unit data or a volume of data relayed per unit time by each of the communication terminals; and
allocating a wider communication band to a communication terminal corresponding to which a greater value indicating the unit data relay frequency is detected.

12. A relay method according to claim 9, wherein:
the controlling is achieved by:
detecting flow control unit data exchanged between a sender and a recipient, which contain control information used in flow control;
relaying the flow control unit data after rewriting the control information; and
allocating the specific communication band to the communication terminal engaged in unit data relay with priority over communication terminals not engaged in the unit data relay data.
